(19) United States
(12) Patent Application Publication
(10) Pub. No.: US 2026/0148398 A1
(43) Pub. Date: May 28, 2026

(54) PANORAMIC DEPTH MAP GENERATION METHOD, MODEL TRAINING METHOD, ELECTRONIC DEVICE, AND UNMANNED VEHICLE

(71) Applicant: Arashi Vision Inc., Shenzhen (CN)

(72) Inventors: Jiang HUALIE, Shenzhen (CN); Xu RUI, Shenzhen (CN)

(73) Assignee: Arashi Vision Inc., Shenzhen (CN)

(21) Appl. No.: 19/002,798

(22) Filed: Dec. 27, 2024

Related U.S. Application Data
(63) Continuation of application No. PCT/CN2024/135410, filed on Nov. 28, 2024.

(51) Int. Cl. G06T 7/50; G05D 1/246; G05D 1/622; G05D 111/10; G06T 3/047; G06T 3/4038; G06V 10/75; G06V 10/82

(52) U.S. Cl. CPC G06T 7/50; G05D 1/2465; G05D 1/622; G06T 3/047; G06T 3/4038; G06V 10/751; G06V 10/82; G05D 2111/10; G06T 2207/10028; G06T 2207/20081; G06T 2207/20084

(57) ABSTRACT

The present disclosure provides a method for generating a panoramic depth map. The method may include grouping target images involving different orientations in a target scene to form at least two image groups, the target images in each of the at least two image groups cover a panoramic field of view of the target scene; performing feature combination on target image feature volumes of each of the image groups to obtain at least two target panoramic feature volumes, each of the target image feature volumes representing three-dimensional stereoscopic features of one of the target images; performing correlation processing on every two of the at least two target panoramic feature volumes to obtain at least one target correlation volume; and performing panoramic depth estimation based on an initial depth map and the at least one target correlation volume to obtain the target panoramic depth map for the target scene.

### CROSS-REFERENCE TO RELATED APPLICATION

The present application is a continuation of International Application No. PCT/CN2024/135410, filed Nov. 28, 2024, the entire content of which being incorporated herein by reference in its entirety.

### TECHNICAL OF FIELD

The present disclosure relates to the field of image processing technology, and in particular to a panoramic depth map generation method, a model training method, an electronic device and an unmanned vehicle.

### BACKGROUND

Panoramic depth estimation based on a surrounding view camera array is a 3D reconstruction method that can obtain a structure of a complete surrounding scene. Panoramic depth estimation is a basic technology used in autonomous mobile robots and mixed reality.

### SUMMARY

In view of the above or other problems, the present disclosure provides a panoramic depth map generation method, a model training method, an electronic device and an unmanned vehicle.

A first aspect of the present disclosure provides a method for generating a panoramic depth map, comprising: grouping target images involving different orientations in a target scene to form at least two image groups, the target images in each of the at least two image groups cover a panoramic field of view of the target scene; performing feature combination on target image feature volumes of each of the image groups to obtain at least two target panoramic feature volumes, each of the target image feature volumes representing three-dimensional stereoscopic features of one of the target images; performing correlation processing on every two of the at least two target panoramic feature volumes to obtain at least one target correlation volume; and performing panoramic depth estimation based on an initial depth map and the at least one target correlation volume to obtain the target panoramic depth map for the target scene.

A second aspect of the present disclosure provides a method for training a depth estimation model, comprising: grouping sample images involving different orientations in a sample scene based on training samples to form at least two sample image groups, the sample images in each of the at least two sample image groups covering a panoramic field of view of the sample scene; performing feature combination on sample image feature volumes of each of the sample image groups to obtain at least two sample panoramic feature volumes, each of the sample image feature volumes representing three-dimensional features of one of the sample images; performing correlation processing on every two of the at least two sample panoramic feature volumes to obtain at least one sample correlation volume; performing panoramic depth estimation based on an initial depth map and the at least one sample correlation volume to obtain a predicted panoramic depth map for the sample scene; determining loss information of the depth estimation model according to the predicted panoramic depth map; adjusting network parameters of the depth estimation model iteratively according to the loss information until the loss information satisfies an iteration stop condition, and determining the network parameters obtained when the loss information satisfies the iteration stop condition as the trained depth estimation model.

A third aspect of the present disclosure provides an electronic device, comprising at least one processor; and at least one memory for storing at least one program, wherein, the at least one processor, when executing the at least one program, is configured to group target images involving different orientations in a target scene to form at least two image groups, the target images in each of the at least two image groups covering a panoramic field of view of the target scene; perform feature combination on target image feature volumes of each of the image groups to obtain at least two target panoramic feature volumes, each of the target image feature volumes representing three-dimensional stereoscopic features of one of the target images; perform correlation processing on every two of the at least two target panoramic feature volumes to obtain at least one target correlation volume; and perform panoramic depth estimation based on an initial depth map and the at least one target correlation volume to obtain the target panoramic depth map for the target scene.

A fourth aspect of the present disclosure provides an unmanned vehicle, comprising the above-mentioned electronic device according to one embodiment of the present disclosure.

A fifth aspect of the present disclosure further provides a computer-readable storage medium on which a computer program or instruction is stored, and the steps of the above method according to one embodiment of the present disclosure are implemented when the above computer program or instruction is executed by a processor.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 schematically shows a scenic diagram of a method for generating a panoramic depth map according to an embodiment of the present disclosure;

FIG. 2 schematically shows a flow chart of a method for generating a panoramic depth map according to an embodiment of the present disclosure;

FIG. 3 schematically shows a flow chart of a method for determining a target image feature volume according to an embodiment of the present disclosure;

FIG. 4 schematically shows a schematic diagram of a method for determining a target correlation volume according to an embodiment of the present disclosure;

FIG. 5 schematically shows a schematic diagram of determining a target weight using an opposite adaptive weighting method according to an embodiment of the present disclosure;

FIG. 6 schematically shows a schematic diagram of determining a target weight using an all weighted method according to an embodiment of the present disclosure;

FIG. 7 schematically shows a schematic diagram of a target weight volume determined by different methods;

FIG. 8 is a flow chart schematically illustrating a method for generating a panoramic depth map according to an embodiment of the present disclosure;

FIG. 9 schematically shows a method for processing an image using a RomniStero model to obtain a panoramic depth map according to an embodiment of the present disclosure;

FIG. 10 schematically shows a flow chart of a method for training a depth estimation model according to an embodiment of the present disclosure;

FIG. 11 schematically shows a structural block diagram of a device for generating a panoramic depth map according to an embodiment of the present disclosure;

FIG. 12 schematically shows a structural block diagram of a training device for a depth estimation model according to an embodiment of the present disclosure; and

FIG. 13 schematically shows a block diagram of an electronic device for implementing the above method according to an embodiment of the present disclosure.

### DETAILED DESCRIPTION

Hereinafter, embodiments of the present disclosure will be described with reference to the accompanying drawings. However, it should be understood that these descriptions are exemplary only and are not intended to limit the scope of the present disclosure. In the following detailed description, for ease of explanation, many specific details are set forth to provide a comprehensive understanding of the embodiments of the present disclosure. However, it is apparent that one or more embodiments may also be implemented without these specific details. In addition, in the following description, descriptions of known structures and technologies are omitted to avoid unnecessary confusion of the concepts of the present disclosure.

The terms used herein are only for describing specific embodiments and are not intended to limit the present disclosure. The terms “include,” “comprising,” etc. used herein indicate presence of the features, steps, operations and/or components, but do not exclude presence or addition of one or more other features, steps, operations or components.

All terms (including technical and scientific terms) used herein have meanings commonly understood by those skilled in the art unless otherwise defined. It should be noted that the terms used herein should be interpreted as having a meaning consistent with the context of this specification and should not be interpreted in an idealized or overly rigid manner.

When expressions such as “at least one of A, B, or C, etc.” are used, they should generally be interpreted according to the meaning of the expression commonly understood by those skilled in the art (for example, “a system having at least one of A, B, or C” should include but is not limited to a system having A alone, B alone, C alone, A and B, A and C, B and C, and/or A, B, C, etc.).

Panoramic stereo matching depth estimation based on a surrounding view camera array is a reliable 3D reconstruction method that can obtain a complete structure of a surrounding scene. It is a basic technology used in autonomous mobile robots and mixed reality. Existing technologies mainly introduce a binocular stereo matching method into the panoramic stereo matching, but the speed and accuracy are not high.

For example, a SweepNet model uses spherical sweeping to construct a cost volume of a panoramic space, realizing semi-global matching (SGM), and can be applied to panoramic stereo matching. The SweepNet model first performs a spherical scan on an input fisheye image to construct a three-dimensional image space (the three dimensions are length, width and discrete sampling depth), and then uses a local convolutional neural network to process each local two-dimensional image block (Patch) of the three-dimensional image space, and constructs the cost volume based on an extracted three-dimensional volume. SweepNet constructs a loss function on the cost volume to train parameters of the above local convolutional neural network through the real panoramic depth of the data set. The above convolutional neural network processes the three-dimensional image space block by block, and the speed is slow due to the large number of processing. In addition, SweepNet uses a semi-global matching method to process the above cost volume. Since it is not end-to-end training, accuracy of the entire model is low.

For example, an OmniMVS model fully implements deep learning for panoramic stereo matching. It uses a 17-layer pure convolutional deep neural network to extract features from four surrounding fisheye images, then obtains the three-dimensional panoramic feature volumes corresponding to the four surrounding fisheye images through spherical scanning, further cascades them as cost volumes, and finally uses an encoder-decoder block based on three-dimensional convolution in the PSMNet algorithm to aggregate the cost volumes to obtain probabilities of each preset discrete depth. The expectation of each preset discrete depth based on this probability prediction is used as the final estimated depth. Since OmniMVS implements deep neural network for the entire model, it can be optimized end-to-end, and both the speed and accuracy are greatly improved compared to SweepNet. However, since the encoder-decoder structure of three-dimensional convolution is usually very complex, the speed and accuracy of OmniMVS are still greatly limited. In addition, since the cost volume of OmniMVS is obtained by cascading the feature volumes generated by each camera, when the number of cameras increases, a larger capacity cost volume will be generated, and the complexity of the subsequent encoder-decoder structure of three-dimensional convolution will further increase. Therefore, the OmniMVS model has poor scalability.

In a field of pinhole image stereo binocular matching, a method based on Recurrent All-Pairs Field Transforms (RAFT) was proposed. RAFT was first applied to optical flow estimation and then extended to stereo matching in RAFT-Stereo. The RAFT-Stereo can achieve higher accuracy than the cost volume aggregation method based on the encoding-decoding structure of 3D convolution, and has smaller memory usage and faster computation time. The RAFT-Stereo starts from a zero disparity map and continuously estimates a disparity residual through a 2D convolutional Gate Recurrent Unit (GRU) to obtain the final disparity map. The input of the 2D GRU is a correlation feature map obtained by sampling a correlation volume according to a series of neighborhood values of the current estimated disparity, and the correlation volume is obtained by calculating correlation between feature maps of a reference image and a target image in the disparity dimension.

However, in the surrounding view multi-view stereo matching, there is no physical panoramic reference image and panoramic target image, so it is difficult to use the RAFT architecture for the surrounding view multi-view stereo matching.

In response to above or other technical problems, the present disclosure introduces a RAFT framework into a multi-view panoramic stereo matching task to construct a flexible, efficient and high-precision cyclic omnidirectional stereo matching model (RomniStero). RomniStereo can construct a virtual reference panoramic feature volume and a target panoramic feature volume according to a given surrounding camera structure, thereby obtaining a panoramic correlation volume according to the reference panoramic feature volume and the target panoramic feature volume, and then sample a relevant feature map on the panoramic correlation volume, and estimate the panoramic depth map through a gated cyclic unit cycle.

FIG. 1 schematically shows a scenic diagram of a method for generating a panoramic depth map according to an embodiment of the present disclosure.

The method for generating a panoramic depth map according to one embodiment of this present disclosure can be applied to a panoramic camera system. As shown in FIG. 1, the panoramic camera system can be an orthogonal four-eye fisheye camera, which includes four outward-facing fisheye cameras located at four corners of a square on a same plane, namely fisheye cameras 101, 102, 103, and 104. A field of view of each fisheye camera is at least 220° to ensure that each direction in the space is covered by more than two cameras.

One embodiment of the present disclosure includes acquiring images, such as image 105, image 106, image 107 and image 108, through the panoramic camera system as shown in FIG. 1, and then input image 105, image 106, image 107 and image 108 into the RomniStereo model 109 provided by the present disclosure for image processing, thereby obtaining a panoramic depth map 110.

It should be noted that in the embodiments of the present disclosure, the panoramic camera system is not limited to four orthogonal fisheye lenses, but at least four fisheye lenses, and there are at least two image groups in the images taken by the at least four fisheye lenses, wherein the images contained in each image group can cover a panoramic field of view. For example, more than four fisheye lenses, such as six fisheye lenses, can be set in the panoramic camera system, and the six fisheye lenses can be divided into at least two image groups, so that the images contained in each image group can cover the panoramic field of view.

It should be understood that the panoramic depth map can distinguish distances of objects in a region, and therefore, obstacles can be determined from the panoramic depth map.

As an application scenario of one embodiment of the present disclosure, the panoramic camera system can be a body of an unmanned vehicle or an external device of the unmanned vehicle. The unmanned vehicle can be either an unmanned aerial vehicle or an unmanned robot. The application of the panoramic camera system on an unmanned vehicle in this embodiment can provide the unmanned vehicle with a panoramic depth map for perceiving surrounding environment, and detect obstacles based on the panoramic depth map, so that the unmanned vehicle can avoid obstacles or implement path planning based on the obstacles.

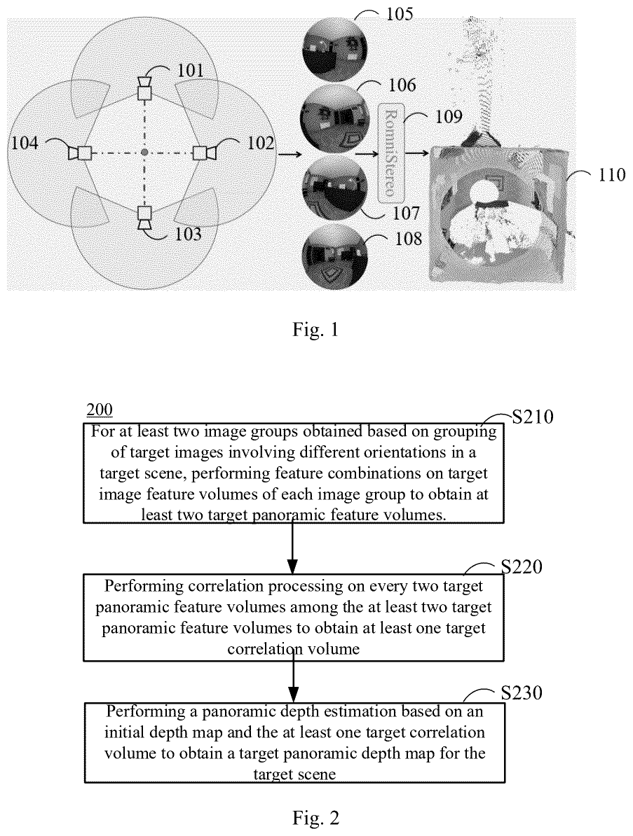

FIG. 2 schematically shows a flow chart of a method for generating a panoramic depth map according to an embodiment of the present disclosure.

A method for generating a panoramic depth map according to one embodiment of the present disclosure 200 includes operations S210 to S230, and the method can be executed by a server or a terminal device, wherein the terminal device can be a camera or an unmanned vehicle.

In one embodiment, operation S210 includes, for at least two image groups obtained based on grouping of target images involving different orientations in a target scene, performing feature combinations on target image feature volumes of each image group to obtain at least two target panoramic feature volumes. The target images included in each image group cover the panoramic field of view of the target scene, and the target image feature volume represents three-dimensional features of the target image.

According to an embodiment of the present disclosure, the target images involving different orientations in the target scene may include target images in at least four orientations. For example, the target images involving different orientations in the target scene may be four target images involving four different orientations, or six target images involving six different orientations.

According to an embodiment of the present disclosure, target images involving different orientations in a target scene may be acquired by using fisheye lenses involving different orientations in the target scene.

For example, the target images involving different orientations may be four target images at different orientations taken by an orthogonal surrounding view four-eye fisheye camera.

According to an embodiment of the present disclosure, target images involving different orientations in a target scene may be acquired by ordinary lenses involving different orientations in the target scene.

According to an embodiment of the present disclosure, the image group is divided according to the following operation: for target images involving different orientations in the target scene, two target images facing back to back are arranged into one image group so as to obtain at least two image groups, wherein the two target images facing back to back represent that the two target images have opposite orientations.

For example, as shown in FIG. 1, there are four fisheye lenses 101, 102, 103, and 104, and the fisheye lens 101 and the fisheye lens 103 are two fisheye lenses facing back to back, and the fisheye lens 102 and the fisheye lens 104 are two fisheye lenses facing back to back, and the image taken by the fisheye lens 101, such as image 105, and the image taken by the fisheye lens 103, such as image 107, are two target images facing back to back, and the image 105 and the image 107 can be arranged into one image group; similarly, the image 106 and the image 108 can be arranged into one image group. It should be noted that the image 105 and the image 107 in the image group can cover a panoramic field of view of the target scene, and the image 106 and the image 108 in the image group can also cover the panoramic field of view of the target scene.

By arranging the two back-to-back target images into one image group, it is possible to ensure that the target images contained in each image group cover the panoramic field of view, and at the same time, a minimum number of target images can be used to calculate the target panoramic feature volume, thereby reducing the amount of calculation.

A target feature volume can be obtained by extracting features from the target image to obtain a feature map and then performing spherical scanning on the feature map. The target feature volume can include a panoramic image size and a preset discrete depth number for the target scene. However, each feature volume is not complete in the two-dimensional space, and each has blank positions, so they cannot be equivalent to a reference frame and a target frame in the correlation volume calculation.

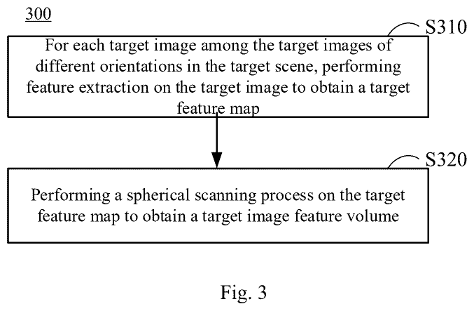

FIG. 3 schematically shows a flow chart of a method for determining a target image feature volume according to one embodiment of the present disclosure.

As shown in FIG. 3, the method for determining a target image feature volume in one embodiment 300 includes operations S310 to S320.

Operation S310 includes, for each target image among the target images of different orientations in the target scene, performing feature extraction on the target image to obtain a target feature map.

The feature extraction of the target image can be performed using operation in Omini MVS. A 2D convolutional neural network may be used to extract features of each target image. The size of the extracted target feature map is H_{f}×W_{f}, which corresponds to the size of the target image.

Operation S320 includes performing a spherical scanning process on the target feature map to obtain a target image feature volume.

Spherical scanning is to map the target image features onto a series of spheres centered at a reference point. By performing spherical scanning on the target feature map, three-dimensional features of each target image, namely the target image feature volume, are obtained; the size of each target image feature volume is Hp×Wp×D, which respectively corresponds to the size of the panoramic image of the target scene and the preset discrete depth number.

Each of the at least two target panoramic feature volumes must cover the entire field of view of the target scene, and there are differences between the at least two target panoramic feature volumes.

In one example, an image group 1 and an image group 2 are included, wherein the image group 1 includes a target image feature volume a1 and a target image feature volume b1, and the image group 2 includes a target image feature volume a2 and a target image feature volume b2. The target image feature volume a1 and the target image feature volume b1 in the image group 1 are feature combined to obtain a target panoramic feature volume c1; the target image feature volume a2 and the target image feature volume b2 in the image group 2 are feature combined to obtain a target panoramic feature volume c2. The target panoramic feature volume c1 and the target panoramic feature volume c2 are obtained by using different combinations of target images, and therefore, the target panoramic feature volume c1 and the target panoramic feature volume c2 are essentially different.

Operation S220 includes performing correlation processing on every two target panoramic feature volumes among the at least two target panoramic feature volumes to obtain at least one target correlation volume.

According to an embodiment of the present disclosure, the performing correlation processing on every two target panoramic feature volumes among the at least two target panoramic feature volumes to obtain at least one target correlation volume includes: performing inner product calculation on every two target panoramic feature volumes among the at least two target panoramic feature volumes to obtain at least one target correlation volume.

In one example, three target panoramic feature volumes are included, namely, target panoramic feature volume a, target panoramic feature volume b and target panoramic feature volume c. The performing inner product calculation on every two target panoramic feature volumes of the at least two target panoramic feature volumes to obtain at least one target correlation volume may include: performing inner product calculation on target panoramic feature volume a and target panoramic feature volume b to obtain target correlation volume ab; performing inner product calculation on target panoramic feature volume a and target panoramic feature volume c to obtain target correlation volume ac; and performing inner product calculation on target panoramic feature volume b and target panoramic feature volume c to obtain target correlation volume bc.

Operation S230 includes performing a panoramic depth estimation based on an initial depth map and the at least one target correlation volume to obtain a target panoramic depth map for the target scene.

According to an embodiment of the present disclosure, at least two image groups are obtained based on grouping target images involving different orientations in a target scene, and feature combination is performed on the target image feature volume of each image group to obtain at least two target panoramic feature volumes; then correlation processing is performed on every two target panoramic feature volumes among the at least two target panoramic feature volumes to obtain at least one target correlation volume; thereafter, panoramic depth estimation is performed based on an initial depth map and the at least one target correlation volume to obtain a target panoramic depth map for the target scene. In this technical solution, a virtual reference panoramic feature volume and a target panoramic feature volume are constructed, so that a target correlation volume is constructed, and a correlation feature map can be sampled on the target correlation volume to perform cyclic iterative estimation of the panoramic depth map, thereby realizing the application of the RAFT architecture to surrounding view panoramic stereo matching, and improving accuracy of panoramic image depth estimation.

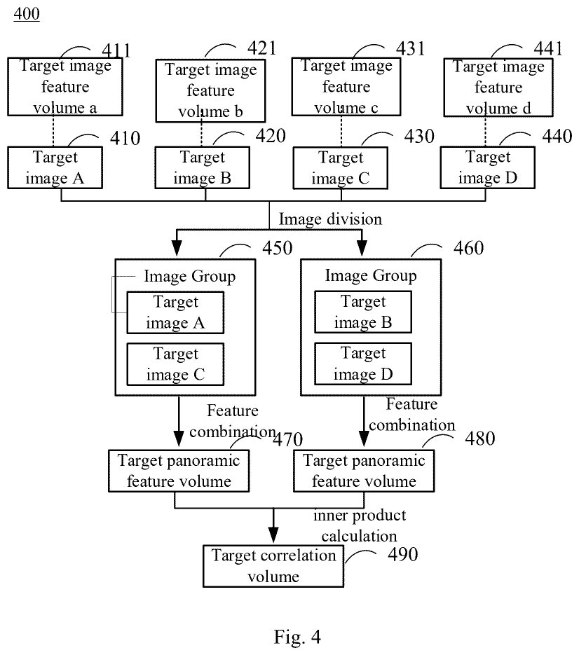

FIG. 4 schematically shows a schematic diagram of a method for determining a target correlation volume according to an embodiment of the present disclosure.

As shown in FIG. 4, the embodiment 400 may include four target images of four orientations taken by an orthogonal surrounding view four-eye fisheye camera for a target scene, namely, target image A 410, target image B 420, target image C 430, and target image D 440. The method for determining the target correlation volume may include the following operations: First, by using the above-mentioned operations S310 and S320 to extract features from the target image A 410, the target image B 420, the target image C 430, and the target image D 440 to obtain a target image feature volume a 411 for the target image A 410, a target image feature volume b 421 for the target image B 420, a target image feature volume c 431 for the target image C 430, and a target image feature volume d 441 for the target image D 440. Then, the target image A 410, the target image B 420, the target image C 430, and the target image D 440 are divided into image groups 450 and 460, wherein the image group 450 may include the target image A 410 and the target image C 430, and the target image A 410 and the target image C 430 may be taken by two fisheye lenses facing back to back; the image group 460 may include the target image B 420 and the target image D 440, and the target image B 420 and the target image D 440 may be taken by two fisheye lenses facing back to back. Afterwards, for the image group 450, the target image feature volume a 411 and the target image feature volume c 431 are feature combined to obtain the target panoramic feature volume 470; for the image group 460, the target image feature volume b 421 and the target image feature volume d 441 are feature combined to obtain the target panoramic feature volume 480. Afterwards, the inner product calculation is performed based on the target panoramic feature volume 470 and the target panoramic feature volume 480 to obtain the target correlation volume 490.

According to an embodiment of the present disclosure, each target image feature volume has a corresponding target weight, and the performing feature combination on the target image feature volume of each image group to obtain at least two target panoramic feature volumes, including: using the target weight of each target image feature volume to perform weighted summation processing on the target image feature volume of each image group to obtain the at least two target panoramic feature volumes.

By performing weighted summation processing according to the target weight of each target image feature volume to obtain the target panoramic feature volume, the obtained target panoramic feature volume can be made closer to the actual scene, thereby helping to improve accuracy of depth estimation.

According to an embodiment of the present disclosure, the target weight of each target image feature volume is determined by the following operations: for each image group, the target image feature volumes in the image group are cascaded to obtain the target image feature volume after the first cascade; and the target image feature volume after the first cascade is subjected to multilayer perception processing to obtain the target weight of each target image feature volume in the image group.

In order to ensure stability of the weights, when inputting into the multilayer perception machine, a sum of the weights of two target image feature volumes, such as target image feature volume a and target image feature volume b, should be 1. In order to achieve this goal and adapt the weights to the target image feature volumes at the same time, an Opposite Adaptive Weighting method is provided, that is, the concatenation of two target image feature volumes is used to predict the weight of one of the target image feature volumes, and then the weight of the other target image feature volume can be obtained by subtracting the predicted weight from 1.

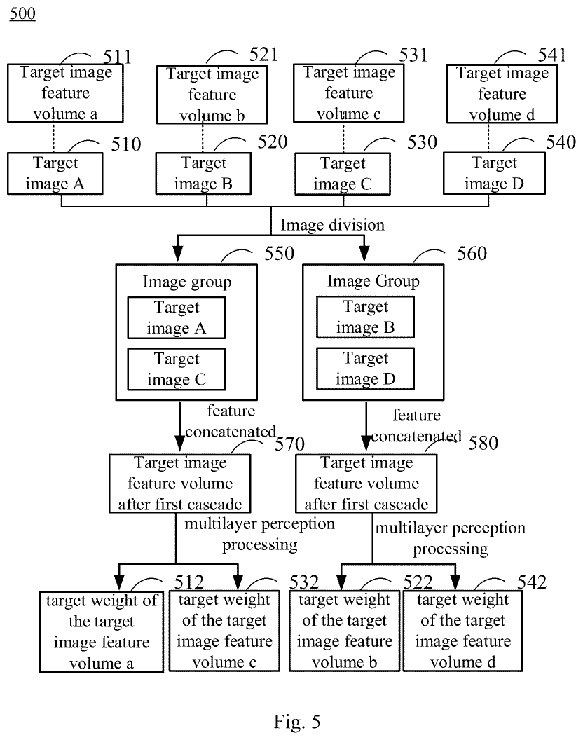

FIG. 5 schematically shows a schematic diagram of determining a target weight using an opposite adaptive weighting method according to an embodiment of the present disclosure.

As shown in FIG. 5, an embodiment 500 includes target image A 510, target image B 520, target image C 530, and target image D 550. A method for determining a target weight of each target image feature volume may include the following operations: first, by using the above-mentioned operations S 310 and S 320 to perform feature extraction on target image A 510, target image B 520, target image C 530, and target image D 550 to obtain a target image feature volume a 511 for target image A 510, a target image feature volume b 521 for target image B 520, a target image feature volume c 531 for target image C 530, and a target image feature volume d 551 for target image D 550. Then, the target image A 510, the target image B 520, the target image C 530, and the target image D 550 are divided into an image group 550 and an image group 560, wherein the image group 550 may include the target image A 510 and the target image C 530; and the image group 560 may include the target image B 520 and the target image D 550. Afterwards, for the image group 550, the target image feature volume a 511 for the target image A 510 and the target image feature volume c 531 for the target image C 530 are feature concatenated to obtain the target image feature volume 570 after first cascade, and the target image feature volume b 5211 for the target image B 520 and the target image feature volume d 551 for the target image D 550 are feature concatenated to obtain the target image feature volume 580 after first cascade. Then, a multilayer perception processing machine is used to estimate the weight volumes of the target image feature volume 570 after the first cascade and the target image feature volume 580 after the first cascade, respectively, to obtain the target weight 512 of the target image feature volume a, the target weight 522 of the target image feature volume b, the target weight 532 of the target image feature volume c, and the target weight 542 of the target image feature volume d.

According to an embodiment of the present disclosure, an Opposite Interleving method is also provided to determine the target weight of each target image feature volume.

For example, the method includes, for each pixel point in the target image feature volume, determining a distance between the pixel point and a target pixel point, where the target pixel point corresponds to a center of the camera; determining a position weight for the pixel point based on the distance; and determining the target weight of the target image feature volume based on the position weight of each pixel point.

The center of the camera may be a line of sight direction, and the target pixel point corresponding to the center of the camera may be a pixel point located on the line of sight direction in the target image feature volume.

For example, when the target image is a fisheye image taken by a fisheye lens, the target pixel point may be a center of the fisheye lens.

According to an embodiment of the present disclosure, the determining the position weight for a pixel point based on the distance includes: when it is determined that the distance is less than a preset distance threshold, determining the position weight of the pixel point to be a first value; when it is determined that the distance is greater than or equal to the preset distance threshold, determining the position weight of the pixel point to be a second value, wherein the first value is different from the second value.

The first value and the second value can be any values, as long as the first value is different from the second value. For example, the first value is any non-zero value, and the second value is zero.

The preset threshold can be determined according to actual needs, and the present disclosure does not limit the specific value of the preset threshold.

By using the Opposite Interleving method, a binary weight is obtained directly based on the distance from the pixel to the center of the camera as an indicator. This weight is the same for different sampling depths.

According to an embodiment of the present disclosure, an all weighting method is also provided to determine the target weight of each target image feature volume.

For example, target image feature volumes of target images at different directions in the target scene are cascaded to obtain a second cascaded target image feature volume; high-level acquisition processing is performed on the second cascaded target image feature volume to obtain a target weight for each target image feature volume.

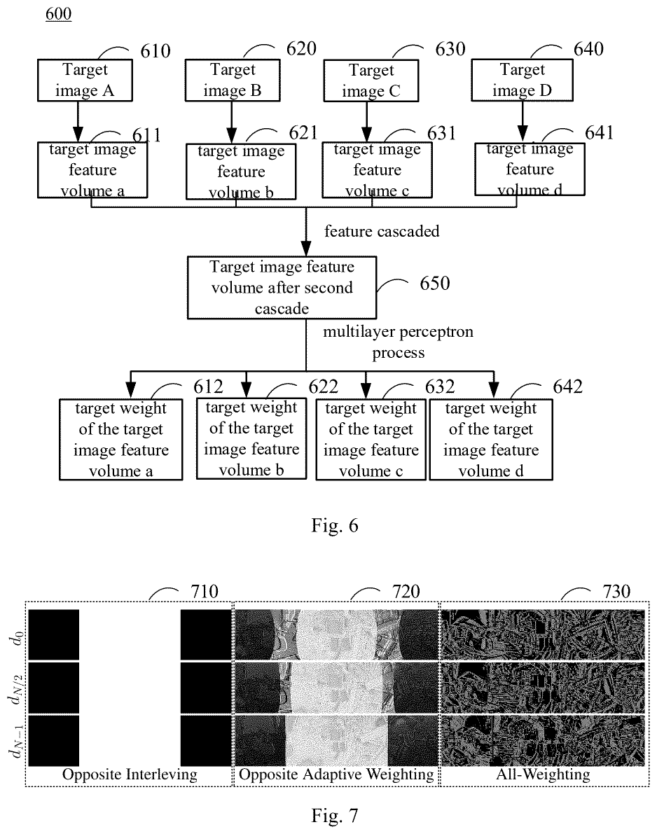

FIG. 6 schematically shows a schematic diagram of determining a target weight using an all-weighting method according to an embodiment of the present disclosure.

As shown in FIG. 6, the embodiment 600 includes a target image A 610, a target image B 620, a target image C 630, and a target image D 640. The method for determining the target weight of each target image feature volume may include: first, by using the above-mentioned operation S310 and operation S320 to extract features from the target image A 610, the target image B 620, the target image C 630, and the target image D 640, respectively, to obtain a target image feature volume a 611 for the target image A 610, a target image feature volume b 621 for the target image B 620, a target image feature volume c 631 for the target image C 630, and a target image feature volume d 641 for the target image D 640. Then, the target image feature volume a 611, the target image feature volume b 621, the target image feature volume c 631, and the target image feature volume d 641 are feature cascaded to obtain a target image feature volume 650 after second cascade. Afterwards, the target image feature volume 650 after the second cascade is input into a multilayer perceptron machine to estimate the weight volume to obtain the target weight 612 of the target image feature volume a, the target weight 622 of the target image feature volume b, the target weight 632 of the target image feature volume c, and the target weight 642 of the target image feature volume d.

FIG. 7 schematically shows a schematic diagram of a target weight volume determined by different methods.

As shown in FIG. 7, the weight maps corresponding to the farthest (d0), middle (dN/2) and nearest (dN−1) sampling depths of the target image feature volumes determined by the above three methods (Opposite Interleving, Opposite Adaptive Weighting, All-Weighting) are listed respectively, for example, weight map 710, weight map 720, and weight map 730.

Weight map 710 obtained by the Opposite Interleving method shown in the first column is fixed for different dₙ because the weights obtained by the Opposite Interleving method are binary. The weight map 720 obtained by the Opposite Adaptive Weighting method shown in the second column can be adaptively changed with dₙ and scene structure. The weight map 730 obtained by the All-Weighting method shown in the third column has discontinuous staggered boundaries.

According to an embodiment of the present disclosure, the performing panoramic depth estimation based on an initial depth map and at least one target correlation volume to obtain a target panoramic depth map for a target scene includes: performing panoramic depth estimation based on the initial depth map, a preset target context feature volume and at least one target correlation volume to obtain the target panoramic depth map for the target scene, wherein the target context feature volume is determined based on at least one target panoramic feature volume.

The initial depth map may be the farthest depth map. In the disclosed embodiment, inverse depth is used, and the farthest place is zero, so the initial depth map may be a zero matrix. The preset target context feature volume may be one of the at least one target panoramic feature volume.

According to an embodiment of the present disclosure, the performing panoramic depth estimation based on an initial depth map, a preset target context feature volume and at least one target correlation volume to obtain a target panoramic depth map for a target scene includes: taking the initial depth map as a current depth estimation map, performing the panoramic depth estimation to obtain a depth estimation increment based on the current depth estimation map, the target context feature volume and at least one target correlation volume; updating the current depth estimation map according to the depth estimation increment to obtain an updated depth estimation map; using the updated depth estimation as the current depth estimation map, repeatedly performing the above operation until the number of loops reaches a first preset loop threshold, thereby obtaining a target panoramic depth map for the target scene.

The updating the current depth estimation map according to the depth estimation increment to obtain the updated depth estimation map may include adding the depth estimation increment to the current depth estimation map to obtain the updated depth estimation map.

The first preset loop threshold may be pre-set, for example, 10 times, 12 times, etc.

It should be noted that in the process of panoramic depth estimation, for the input target image, there will first be an initial depth map D_0 (for example, the depth is all 0), and then a series of depth estimation sequences D_1, D_2, . . . , D_n are obtained by cyclic iteration, and then the last of these depth estimation sequences is used as the target panoramic depth map.

According to an embodiment of the present disclosure, the performing panoramic depth estimation based on the current depth estimation map, the target context feature volume and at least one target correlation volume to obtain a depth estimation increment includes: using the current depth estimation map and a preset sampling neighborhood value to respectively sample the target context feature volume and the at least one target correlation volume to obtain a current context feature map and a current correlation feature map; using the current context feature map and the current correlation feature map to perform panoramic depth estimation to obtain the depth estimation increment.

The using the current depth estimation map and the preset sampling neighborhood value to respectively sample the target context feature volume and the at least one target correlation volume to obtain the current context feature map and the current correlation feature map includes: using the current depth estimation map and the preset sampling neighborhood value to sample from the target context feature volume to obtain the current context feature map; using the current depth estimation map and the preset sampling neighborhood value to sample from the at least one target correlation volume to obtain the current correlation feature map.

When the number of target correlation volumes is greater than one, the following method may be used to determine the current correlation feature map.

In one example, information of multiple target correlation volumes is combined to obtain a joint correlation volume, and a current correlation feature map is obtained by sampling from the joint correlation volume using a current depth estimation map and a preset sampling neighborhood value. The combining information of multiple target correlation volumes may include connecting features of the multiple target correlation volumes by channel.

For example, for target correlation volume 1, target correlation volume 2, and target correlation volume 3, when determining the current correlation feature map, the information of target correlation volume 1, target correlation volume 2, and target correlation volume 3 can be combined to obtain a joint correlation volume, and then the current depth estimation map and the preset sampling neighborhood value are used to sample from the joint correlation volume to obtain the current correlation feature map.

In another example, the current depth estimation map and the preset sampling neighborhood value are used to sample from multiple target correlation volumes respectively to obtain multiple sampling results, and the information of the multiple sampling results is combined to obtain the current correlation volume feature map. For example, for target correlation volume 1, target correlation volume 2, and target correlation volume 3, when determining the current correlation feature map, the current depth estimation map and the preset sampling neighborhood value can be used to sample from target correlation volume 1 to obtain sampling result 1, the current depth estimation map and the preset sampling neighborhood value can be used to sample from target correlation volume 2 to obtain sampling result 2, and the current depth estimation map and the preset sampling neighborhood value can be used to sample from target correlation volume 3 to obtain sampling result 3, and then the information of sampling result 1, sampling result 2, and sampling result 3 are combined to obtain the current correlation feature map.

Using the current context feature map and the current correlation feature map to perform panoramic depth estimation and obtain the depth estimation increment may include inputting the current context feature map and the current correlation feature map into a GRU module of the RomniStereo model to perform depth estimation and output a depth estimation increment.

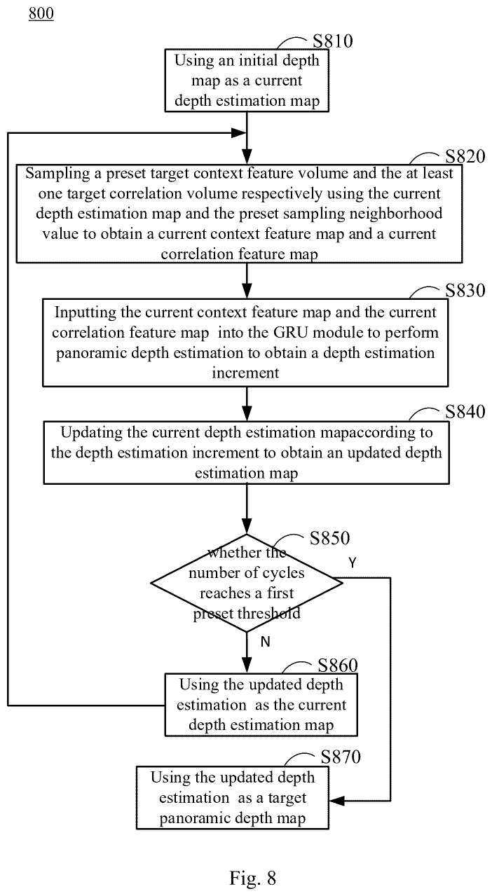

FIG. 8 is a flow chart schematically illustrating a method for generating a panoramic depth map according to one embodiment of the present disclosure.

The method for generating a panoramic depth map of the embodiment 800 includes operations S810 to S870 in addition to the above-mentioned operations S210 and S220.

In operation S810, an initial depth map is used as a current depth estimation map.

In operation S820, a preset target context feature volume and the at least one target correlation volume are respectively sampled using the current depth estimation map and the preset sampling neighborhood value to obtain a current context feature map and a current correlation feature map.

In operation S830, the current context feature map and the current correlation feature map are input into the GRU module to perform panoramic depth estimation to obtain a depth estimation increment.

In operation S840, the current depth estimation map is updated according to the depth estimation increment to obtain an updated depth estimation map.

In operation S850, it is determined whether the number of cycles reaches a first preset threshold. If so, operation S870 is performed; if not, operation S860 is performed.

In operation S860, the updated depth estimation is used as the current depth estimation map, and then operation S820 is performed.

In operation S870, the updated depth estimation is used as a target panoramic depth map.

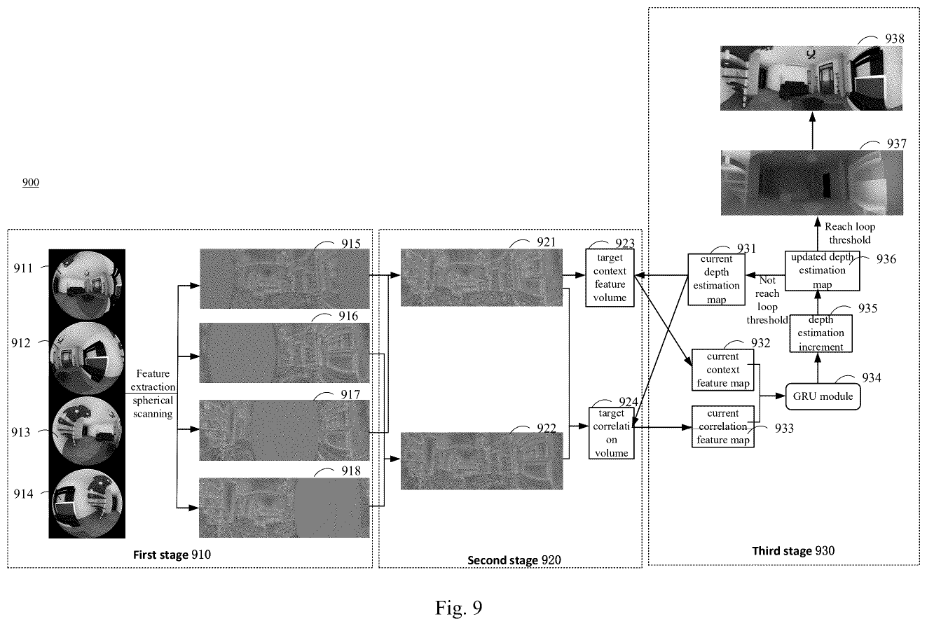

FIG. 9 schematically shows a method for processing an image using a RomniStero model to obtain a panoramic depth map according to one embodiment of the present disclosure.

As shown in FIG. 9, the surrounding view camera in embodiment 900 includes four fisheye cameras, and the four fisheye cameras respectively collect images at four orientations of the target scene. The method for generating a panoramic depth map of this embodiment includes a first stage 910, a second stage 920, and a third stage 930.

In the first stage 910, first, feature extraction and spherical scanning are performed on the fisheye image 911, the fisheye image 912, the fisheye image 913, and the fisheye image 914 collected by the surrounding view camera, respectively, to obtain a target image feature volume 915 for the fisheye image 911, a target image feature volume 916 for the fisheye image 912, a target image feature volume 917 for the fisheye image 913, and a target image feature volume 918 for the fisheye image 914, wherein the fisheye image 911 and the fisheye image 913 are two images facing back to back, and the fisheye image 912 and the fisheye image 914 are two images facing back to back, therefore, the fisheye image 911 and the fisheye image 913 are arranged into a first image group, and the fisheye image 912 and the fisheye image 914 are arranged into a second image group.

In the second stage 920, for the fisheye image 911 and the fisheye image 913 in the first image group, the target image feature volume 915 for the fisheye image 911 and the target image feature volume 917 for the fisheye image 913 are feature combined to obtain a target panoramic feature volume 921; for the fisheye image 912 and the fisheye image 914 in the second image group, the target image feature volume 916 for the fisheye image 912 and the target image feature volume 918 for the fisheye image 914 are feature combined to obtain a target panoramic feature volume 922; then, correlation calculation is performed based on the target panoramic feature volume 921 and the target panoramic feature volume 922 to obtain a target correlation volume 924; and a context feature volume is initialized based on the target panoramic feature volume 921 to obtain a target context feature volume 923.

In the third stage 930, an initial depth map is first used as the current depth estimation map, and a current context feature map 932 is obtained by sampling from the target context feature volume 923 according to the current depth estimation map 931, and a current correlation feature map 933 is obtained by sampling from the target correlation volume 924 according to the current depth estimation map 931; then the current context feature map 932 and the current correlation feature map 933 are input into the GRU module for depth estimation, and the depth estimation increment 935 is output, and the current depth estimation map is updated according to the depth estimation increment to obtain an updated depth estimation map 936; if the loop threshold is not reached at this time, the updated depth estimation map 936 is used as the current depth estimation map 931 for loop iteration; if the loop threshold is reached at this time, the updated depth estimation map 936 is output to obtain the target panoramic depth map 937, and the scene is reconstructed according to the target panoramic depth map 937 to obtain a reconstructed image 938 of the target scene.

According to an embodiment of the present disclosure, an effective model for surrounding view panoramic depth estimation, namely the RomniStero model, is proposed, which realizes the extension of the RAFT framework to the surrounding multi-eye panoramic stereo matching task. In order to narrow the gap between OSM and traditional pinhole image matching, the present disclosure uses the camera structure to construct a target correlation volume before adaptively combining opposing views for subsequent loop processing. In addition, the present disclosure also introduces two beneficial technologies into the RomniStereo model: grid embedding such as the embedding of a multilayer perceptron machine and adaptive context feature generation such as automatically generating a context feature volume using one of the target correlation volumes. A large number of experiments have proved the effectiveness and efficiency of this method.

According to some embodiments of the present disclosure, the surrounding view panoramic depth estimation model (RomniStereo model) of the present disclosure and the panoramic depth estimation models (S-OmiNVS model, OmiNVS model) of related technologies are evaluated using the data sets OmniThings (OT), OminiHouse (OH), Sunny (Sn), Cloudy (Cd), and Sunset (Ss). The results are shown in Tables 1 and 2.

Combining Table 1 and Table 2, it can be seen that the speed of the RomniStereo model provided by one embodiment of the present disclosure is twice as fast as the original OmniMVS model, and in many model configurations and test data set evaluations, it has shown a small depth estimation error. Among them, the best model configuration of the surrounding panoramic depth estimation model in one embodiment of the present disclosure has an average reduction of 40.7% in the mean error (MAE) on 5 data sets compared to the best model configuration of the OmniMVS model.

TABLE 1

| | Dataset | | | | | | | | | | |
|---|---|---|---|---|---|---|---|---|---|---|---|
| | OmniThings | | | | | OmniHouse | | | | | Run Time |
| Metric | >1 | >3 | >5 | MAE | RMS | >1 | >3 | >5 | MAE | RMS | (s) |

Non-learning based method

| | | | | | | | | | | | |
|---|---|---|---|---|---|---|---|---|---|---|---|
| Sphere-Stereo [23] | 80.01 | 56.67 | 44.06 | 9.14 | 14.06 | 65.84 | 27.29 | 12.84 | 2.82 | 4.60 | 0.21 |

Trained on OmniThings only

| | | | | | | | | | | | |
|---|---|---|---|---|---|---|---|---|---|---|---|
| OmniMVS [symbol] [12] | 46.01 | 21.00 | 13.59 | 2.97 | 6.48 | 37.77 | 13.80 | 7.43 | 1.88 | 3.93 | 0.11 |
| RomniStereo [symbol] | 35.61 | 17.05 | 11.46 | 2.52 | 6.13 | 21.82 | 9.24 | 5.67 | 1.33 | 2.96 | 0.09 |
| OmniMVS [symbol] [12] | 32.26 | 13.36 | 8.67 | 2.05 | 5.21 | 29.52 | 10.34 | 5.96 | 1.62 | 3.53 | 0.19 |
| RomniStereo [symbol] | 28.67 | 12.90 | 8.64 | 1.99 | 5.31 | 20.02 | 8.00 | 4.70 | 1.17 | 2.66 | 0.10 |
| OmniMVS [symbol] [11] | 47.72 | 15.12 | 8.91 | 2.40 | 5.27 | 30.53 | 10.29 | 6.27 | 1.72 | 4.05 | 0.82 |
| S-OmniMVS [13] | 28.03 | 10.40 | 6.33 | 1.48 | 3.68 | 18.86 | 8.05 | 4.90 | 1.06 | 2.41 | — |
| OmniMVS [symbol] -IS [12] | 24.11 | 9.38 | 5.84 | 1.45 | 4.14 | 23.91 | 8.97 | 5.63 | 1.41 | 3.33 | 0.72 |
| OmniMVS [symbol] [12] | 20.70 | 8.18 | 5.49 | 1.37 | 4.11 | 19.89 | 5.89 | 3.99 | 1.30 | 2.64 | 0.82 |
| RomniStereo [symbol] | 20.42 | 8.49 | 5.81 | 1.39 | 4.22 | 12.13 | 4.73 | 3.02 | 0.80 | 1.85 | 0.21 |
| RomniStereo [symbol] | 17.77 | 7.52 | 5.00 | 1.22 | 3.90 | 10.52 | 4.05 | 2.69 | 0.74 | 1.73 | 0.44 |

Finetuned on OmniHouse and Sunny

| | | | | | | | | | | | |
|---|---|---|---|---|---|---|---|---|---|---|---|
| OmniMVS [symbol] -ft [12] | 53.99 | 35.38 | 27.57 | 5.68 | 9.98 | 15.40 | 5.00 | 2.85 | 0.86 | 1.98 | 0.11 |
| RomniStereo [symbol] -ft | 50.01 | 33.22 | 26.30 | 5.38 | 9.59 | 11.45 | 4.52 | 2.89 | 0.77 | 1.92 | 0.09 |
| RomniStereo [symbol] -ft | 44.50 | 28.61 | 22.05 | 4.43 | 8.46 | 8.66 | 3.36 | 2.14 | 0.59 | 1.56 | 0.10 |
| OmniMVS-ft [11] | 50.28 | 22.78 | 15.60 | 3.52 | 7.44 | 21.09 | 4.63 | 2.58 | 1.04 | 1.97 | 0.82 |
| S-OmniMVS-ft [13] | — | — | — | — | — | 6.99 | 1.79 | 0.97 | 0.42 | 1.06 | — |
| OmniMVS [symbol] -ft [12] | 44.79 | 27.17 | 20.41 | 4.23 | 8.42 | 9.70 | 3.51 | 2.13 | 0.64 | 1.69 | 0.82 |
| RomniStereo [symbol] -ft | 34.32 | 19.76 | 14.22 | 2.81 | 6.47 | 6.02 | 2.49 | 1.73 | 0.49 | 1.31 | 0.21 |
| RomniStereo [symbol] -ft | 29.84 | 16.21 | 11.28 | 2.26 | 5.60 | 5.28 | 2.22 | 1.51 | 0.42 | 1.14 | 0.44 |

[symbol]

indicates data missing or illegible when filed

TABLE 2

| | Dataset | | | | | | | | | | | | | | |
|---|---|---|---|---|---|---|---|---|---|---|---|---|---|---|---|
| | Sunny | | | | | Cloudy | | | | | Sunset | | | | |
| Metric | >1 | >3 | >5 | MAE | RMS | >1 | >3 | >5 | MAE | RMS | >1 | >3 | >5 | MAE | RMS |

Non-learning based method

| | | | | | | | | | | | | | | | |
|---|---|---|---|---|---|---|---|---|---|---|---|---|---|---|---|
| Sphere-Stereo [23] | 76.46 | 45.99 | 28.46 | 4.92 | 8.35 | 77.57 | 47.08 | 28.39 | 4.50 | 7.21 | 77.38 | 46.11 | 28.49 | 5.15 | 8.89 |

Trained on OmniThings only

| | | | | | | | | | | | | | | | |
|---|---|---|---|---|---|---|---|---|---|---|---|---|---|---|---|
| OmniMVS [symbol] [12] | 26.18 | 7.06 | 4.37 | 1.24 | 3.06 | 28.50 | 6.62 | 3.93 | 1.23 | 2.92 | 25.29 | 6.92 | 4.18 | 1.22 | 3.06 |
| RomniStereo [symbol] | 17.34 | 6.92 | 4.54 | 1.06 | 3.30 | 16.65 | 6.30 | 4.09 | 1.01 | 3.04 | 16.77 | 6.63 | 4.28 | 1.04 | 3.27 |
| OmniMVS [symbol] [12] | 18.49 | 6.13 | 3.93 | 1.10 | 3.07 | 18.85 | 5.89 | 3.72 | 1.08 | 2.94 | 17.99 | 6.08 | 3.85 | 1.09 | 3.02 |
| RomniStereo [symbol] | 15.46 | 6.54 | 4.41 | 0.99 | 3.12 | 15.14 | 6.09 | 4.10 | 0.95 | 2.97 | 15.25 | 6.42 | 4.24 | 0.98 | 3.12 |
| OmniMVS [11] | 27.16 | 6.13 | 3.98 | 1.24 | 3.09 | 28.13 | 5.37 | 3.54 | 1.17 | 2.83 | 26.70 | 6.19 | 4.02 | 1.24 | 3.06 |
| S-OmniMVS [13] | 17.19 | 6.03 | 3.89 | 1.11 | 3.60 | — | — | — | — | — | — | — | — | — | — |
| OmniMVS [symbol] -IS [12] | 17.46 | 5.73 | 3.60 | 0.99 | 2.76 | 17.67 | 5.84 | 3.82 | 1.04 | 3.00 | 17.28 | 5.63 | 3.42 | 0.98 | 2.71 |
| OmniMVS [symbol] [12] | 13.57 | 4.81 | 3.10 | 0.88 | 2.56 | 13.59 | 4.81 | 3.15 | 0.87 | 2.53 | 13.36 | 4.71 | 2.93 | 0.87 | 2.50 |
| RomniStereo [symbol] | 12.28 | 5.59 | 3.79 | 0.80 | 2.68 | 11.86 | 5.08 | 3.44 | 0.75 | 2.50 | 12.30 | 5.45 | 3.48 | 0.78 | 2.67 |
| RomniStereo [symbol] | 11.25 | 5.30 | 3.59 | 0.75 | 2.57 | 10.97 | 5.03 | 3.44 | 0.73 | 2.47 | 10.94 | 4.99 | 3.29 | 0.72 | 2.56 |

Finetuned on OmniHouse and Sunny

| | | | | | | | | | | | | | | | |
|---|---|---|---|---|---|---|---|---|---|---|---|---|---|---|---|
| OmniMVS [symbol] -ft [12] | 10.54 | 3.42 | 2.11 | 0.65 | 2.06 | 10.22 | 3.19 | 1.92 | 0.61 | 1.94 | 10.81 | 3.64 | 2.21 | 0.66 | 2.11 |
| RomniStereo [symbol] -ft | 9.30 | 3.47 | 2.21 | 0.60 | 2.25 | 9.54 | 3.47 | 2.17 | 0.60 | 2.20 | 9.48 | 3.57 | 2.27 | 0.60 | 2.25 |
| RomniStereo [symbol] -ft | 7.38 | 2.75 | 1.72 | 0.48 | 1.92 | 7.53 | 2.69 | 1.66 | 0.48 | 1.87 | 7.65 | 2.94 | 1.86 | 0.50 | 2.01 |
| OmniMVS-ft [symbol] | 13.93 | 2.87 | 1.71 | 0.79 | 2.12 | 12.20 | 2.48 | 1.46 | 0.72 | 1.85 | 14.14 | 2.88 | 1.71 | 0.79 | 2.04 |
| S-OmniMVS-ft [13] | 6.66 | 2.18 | 1.40 | 0.47 | 1.98 | — | — | — | — | — | — | — | — | — | — |
| OmniMVS [symbol] -ft [12] | 7.48 | 3.57 | 2.42 | 0.57 | 2.42 | 7.29 | 3.38 | 2.30 | 0.54 | 2.31 | 7.82 | 3.60 | 2.42 | 0.58 | 2.36 |
| RomniStereo [symbol] -ft | 5.19 | 1.98 | 1.23 | 0.36 | 1.55 | 5.63 | 2.03 | 1.29 | 0.39 | 1.72 | 5.53 | 2.13 | 1.34 | 0.37 | 1.61 |
| RomniStereo [symbol] -ft | 4.61 | 1.78 | 1.10 | 0.32 | 1.43 | 4.94 | 1.83 | 1.16 | 0.34 | 1.53 | 4.88 | 1.90 | 1.19 | 0.34 | 1.49 |

[symbol]

indicates data missing or illegible when filed

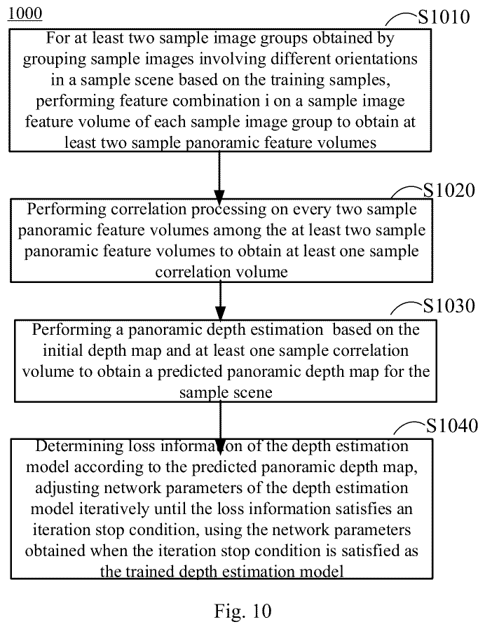

FIG. 10 schematically shows a flow chart of a method for training a depth estimation model according to an embodiment of the present disclosure.

As shown in FIG. 10, the method of training the depth estimation model of this embodiment includes operations S1010 to S1040.

In operation S1010, for at least two sample image groups obtained by grouping sample images involving different orientations in a sample scene based on the training samples, feature combination is performed on a sample image feature volume of each sample image group to obtain at least two sample panoramic feature volumes, wherein the sample images included in each sample image group cover a panoramic field of view of the sample scene, and the sample image feature volume represents three-dimensional stereoscopic features of the sample image.

In operation S1020, correlation processing is performed on every two sample panoramic feature volumes among the at least two sample panoramic feature volumes to obtain at least one sample correlation volume.

In operation S1030, a panoramic depth estimation is performed based on the initial depth map and at least one sample correlation volume to obtain a predicted panoramic depth map for the sample scene.

In operation S1040, loss information of the depth estimation model is determined according to the predicted panoramic depth map, and network parameters of the depth estimation model are iteratively adjusted according to the loss information until the loss information satisfies an iteration stop condition, and the network parameters obtained when the iteration stop condition is satisfied are used as the trained depth estimation model.

According to an embodiment of the present disclosure, the method may further include acquiring a sample panoramic depth map for the sample scene.

The iteration stop condition may include a preset number of iterations, and may also minimize an error between the predicted panoramic depth map and the sample panoramic depth map.

For example, the determining the loss information of the depth estimation model according to the predicted panoramic depth map may include determining a loss value of the predicted panoramic depth map and the sample panoramic depth map based on a preset loss function, and stopping iteration when the loss value is less than a preset threshold.

According to an embodiment of the present disclosure, each sample image feature volume has its own sample weight, and the performing feature combination on the sample image feature volume of each sample image to obtain at least two sample panoramic feature volumes includes:

processing sample image feature volumes of each sample image group by weighted summation using the sample weight of each sample image feature volume to obtain the at least two sample panoramic feature volumes.

According to an embodiment of the present disclosure, each sample image feature volume has its own sample weight determined by the following operation:
For each sample image group, performing cascade processing on the sample image feature volumes in the sample image group to obtain the sample image feature volumes after the first cascade; and
performing multilayer perception processing on the sample image feature volumes after the first cascade to obtain sample weights of the sample image feature volumes in the sample image group.

According to an embodiment of the present disclosure, each sample image feature volume has its own sample weight determined by the following operation:
For each sample pixel point in the sample image feature volume, determining a distance between the sample pixel point and the target sample pixel point;
determining a position weight for the sample pixel point according to the distance; and
determining the sample weight of the sample image feature volume according to the position weight of each sample pixel.

According to an embodiment of the present disclosure, the determining a position weight for a sample pixel point according to the distance includes:
when it is determined that the distance is less than a preset distance threshold, determining the position weight of the sample pixel point to be a first value;
when it is determined that the distance is greater than or equal to the preset distance threshold, determining the position weight of the sample pixel point to be a second value, wherein the first value is different from the second value.

According to an embodiment of the present disclosure, each sample image feature volume has its own sample weight determined by the following operation:
performing cascade processing on sample image feature volumes of sample images at different orientations in the sample scene to obtain a sample image feature volume after the second cascade; and
performing multilayer perception processing on the sample image feature volume after the second cascade to obtain the sample weight of each sample image feature volume.

According to an embodiment of the present disclosure, the sample image group is organized using the following operations:

For sample images involving different orientations in the sample scene, two sample images facing back to back are arranged into a sample image group to obtain at least two sample image groups, wherein the two sample images facing back to back represent that the orientations of the two sample images are opposite.

According to an embodiment of the present disclosure, the performing correlation processing on every two sample panoramic feature volumes of the at least two sample panoramic feature volumes to obtain at least one sample correlation volume includes:

performing an inner product calculation on every two sample panoramic feature volumes of the at least two sample panoramic feature volumes to obtain at least one sample correlation volume.

According to an embodiment of the present disclosure, the performing panoramic depth estimation based on an initial depth map and at least one sample correlation volume to obtain a sample panoramic depth map for a sample scene includes:
performing a panoramic depth estimation based on an initial depth map, a preset sample context feature volume and at least one sample correlation volume to obtain a sample panoramic depth map for the sample scene, wherein the sample context feature volume is determined based on the at least one sample panoramic feature volume.

According to an embodiment of the present disclosure, performing panoramic depth estimation based on an initial depth map, a preset sample context feature volume, and at least one sample correlation volume to obtain a sample panoramic depth map for a sample scene includes:
taking the initial depth map as the current sample depth estimation map, performing panoramic depth estimation based on the current sample depth estimation map, a sample context feature volume and at least one sample correlation volume to obtain a sample depth estimation increment;
updating the current sample depth estimation map according to the sample depth estimation increment to obtain an updated sample estimation depth map;
using the updated sample depth estimation as the current sample depth estimation map, and performing the above operations in a loop until the number of loops reaches a second preset loop threshold, thereby obtaining a sample panoramic depth map for the sample scene.

According to an embodiment of the present disclosure, the performing panoramic depth estimation based on a current depth estimation map, a sample context feature volume, and at least one sample correlation volume to obtain a sample depth estimation increment includes:
using the current sample depth estimation map and the preset sampling neighborhood value, respectively sampling a sample context feature volume and at least one sample correlation volume to obtain a current sample context feature map and a current sample correlation feature map; and
performing the panoramic depth estimation using the current sample context feature map and the current sample correlation feature map to obtain the sample depth estimation increment.

According to an embodiment of the present disclosure, the method further includes:
for each sample image in the sample images of different orientations in the sample scene, performing feature extraction on the sample image to obtain a sample feature map; and
performing spherical scanning processing on the sample feature map to obtain the sample image feature volume.

According to an embodiment of the present disclosure, the sample images involving different orientations in the sample scene include sample images in at least four orientations.

According to an embodiment of the present disclosure, sample images involving different orientations in a sample scene are acquired by using fisheye lenses involving different orientations in the sample scene.

According to an embodiment of the present disclosure, the method of training the depth estimation model is the similar as the method for generating the panoramic depth map described above, and will not be described in detail here.

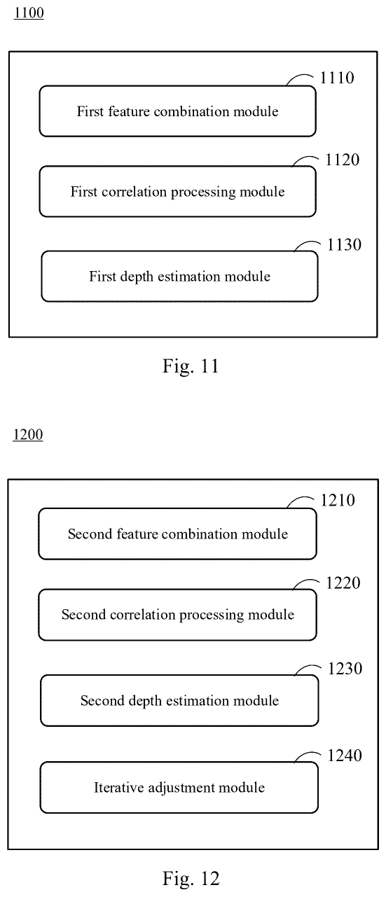

Based on the above-mentioned method for generating a panoramic depth map, one embodiment of the present disclosure further provides a device for generating a panoramic depth map. The device will be described in detail below in conjunction with FIG. 11.

FIG. 11 schematically shows a structural block diagram of a device for generating a panoramic depth map according to an embodiment of the present disclosure.

As shown in FIG. 11, the panoramic depth map generating device 1100 of this embodiment includes a first feature combining module 1110, a first correlation processing module 1120 and a first depth estimating module 1130.

The first feature combination module 1110 is configured to combine the features of the target image feature volumes of each image group for at least two image groups obtained based on the target image grouping involving different orientations in the target scene, so as to obtain at least two target panoramic feature volumes, wherein the target images contained in each image group cover the panoramic field of view of the target scene, and the target image feature volume represents three-dimensional stereoscopic features of the target image. In one embodiment, the first feature combination module 1110 can be used to perform the operation S210 described above, which will not be repeated here.

The first correlation processing module 1120 is configured to perform correlation processing on every two target panoramic feature volumes in at least two target panoramic feature volumes to obtain at least one target correlation volume. In one embodiment, the first correlation processing module 1120 can be used to perform the operation S220 described above, which will not be described in detail here.

The first depth estimation module 1130 is configured to perform panoramic depth estimation based on the initial depth map and at least one target correlation volume to obtain a target panoramic depth map for the target scene. In one embodiment, the first depth estimation module 1130 can be used to perform the operation S230 described above, which will not be repeated here.

According to an embodiment of the present disclosure, each target image feature volume has a corresponding target weight.

According to an embodiment of the present disclosure, the first feature combination module includes: a first weighted sum processing submodule.

The first weighted sum processing submodule is configured to perform weighted sum processing on the target image feature volumes of each image group using the target weight of each target image feature volume to obtain at least two target panoramic feature volumes.

According to an embodiment of the present disclosure, the device for generating a panoramic depth map further includes: a first cascade module and a first multilayer perception module.

The first cascade module is configured to perform cascade processing on the target image feature volumes in each image group to obtain the target image feature volume after the first cascade.

The first multilayer perception module is configured to perform multilayer perception processing on the target image feature volume after the first cascade to obtain the target weights of the target image feature volumes in the image group.

According to an embodiment of the present disclosure, the device for generating a panoramic depth map further includes: a first determination module, a second determination module and a third determination module.

The first determination module is configured to determine, for each pixel point in the target image feature volume, a distance between the pixel point and the target pixel point, wherein the target pixel point corresponds to the center of the camera.

The second determination module is configured to determine a position weight for the pixel point according to the distance.

The third determination module is configured to determine the target weight of the target image feature volume according to the position weight of each pixel point.

According to an embodiment of the present disclosure, the second determination module includes: a first determination submodule and a second determination submodule.

The first determination submodule is configured to determine that the position weight of the pixel point is a first value when the determined distance is less than a preset distance threshold.

The second determination submodule is configured to determine that the position weight of the pixel point is a second value when the distance is greater than or equal to a preset distance threshold, wherein the first value is different from the second value.

According to an embodiment of the present disclosure, the device for generating a panoramic depth map further includes: a second cascade module and a second multilayer perception module.

The second cascade module is configured to perform cascade processing on target image feature volumes of target images in different orientations in the target scene to obtain a target image feature volume after the second cascade.

The second multilayer perception module is configured to perform multilayer perception processing on the target image feature volume after the second cascade to obtain the target weight of each target image feature volume.

According to an embodiment of the present disclosure, the device for generating a panoramic depth map further includes: a first division module.

The first division module is configured to arrange two target images facing back to back into one image group for target images with different orientations in the target scene, thereby obtaining at least two image groups, wherein the two target images facing back to back represent that the orientations of the two target images are opposite.

According to an embodiment of the present disclosure, the first correlation processing module includes: a first inner product calculation submodule.

The first inner product calculation submodule is configured to perform inner product calculation on every two target panoramic feature volumes of the at least two target panoramic feature volumes to obtain at least one target correlation volume.

According to an embodiment of the present disclosure, the first depth estimation module includes: a first depth estimation submodule.

The first depth estimation submodule is configured to perform panoramic depth estimation based on an initial depth map, a preset target context feature volume and at least one target correlation volume to obtain a target panoramic depth map for a target scene, wherein the target context feature volume is determined based on at least one target panoramic feature volume.

According to an embodiment of the present disclosure, the first depth estimation submodule includes: a first depth estimation unit, a first updating unit, and a first circulation unit.

A first depth estimation unit is configured to use the initial depth map as a current depth estimation map. A panoramic depth estimation is performed based on the current depth estimation map, the target context feature volume and at least one target correlation volume to obtain a depth estimation increment.

The first updating unit is configured to update the current depth estimation map according to the depth estimation increment to obtain an updated depth estimation map.

The first loop unit is configured to use the updated depth estimation as the current depth estimation map, and cyclically perform the above operations until the number of loops reaches a first preset loop threshold, thereby obtaining a target panoramic depth map for the target scene.

According to an embodiment of the present disclosure, the first depth estimation unit includes: a first sampling subunit and a first depth estimation subunit.

The first sampling subunit is configured to respectively sample a target context feature volume and at least one target correlation volume using a current depth estimation map and a preset sampling neighborhood value to obtain a current context feature map and a current correlation feature map.

The first depth estimation subunit is configured to perform panoramic depth estimation using the current context feature map and the current correlation feature map to obtain a depth estimation increment.

According to an embodiment of the present disclosure, the device for generating a panoramic depth map further includes: a first feature extraction module and a first spherical scanning module.

The first feature extraction module is configured to extract features from each target image in target images of different orientations in the target scene to obtain a target feature map.

The first spherical scanning module is used to perform spherical scanning processing on the target feature map to obtain a target image feature volume.

According to an embodiment of the present disclosure, target images involving different orientations in a target scene include target images in at least four orientations.

According to an embodiment of the present disclosure, target images involving different orientations in a target scene are acquired by fisheye lenses involving different orientations in the target scene.

According to an embodiment of the present disclosure, the device for generating a depth map further includes: an obstacle determination module.

The obstacle determination module is configured to determine obstacles based on the panoramic depth map so that the unmanned vehicle can perform obstacle avoidance based on the obstacles.

According to an embodiment of the present disclosure, any multiple modules of the first feature combination module 1110, the first correlation processing module 1120, and the first depth estimation module 1130 can be combined into one module for implementation, or any one of the modules can be split into multiple modules. Alternatively, at least part of the functions of one or more of these modules can be combined with at least part of the functions of other modules and implemented in one module. According to an embodiment of the present disclosure, at least one of the first feature combination module 1110, the first correlation processing module 1120, and the first depth estimation module 1130 can be at least partially implemented as a hardware circuit, such as a field programmable gate array (FPGA), a programmable logic array (PLA), a system on a chip, a system on a substrate, a system on a package, an application specific integrated circuit (ASIC), or can be implemented by hardware or firmware such as any other reasonable way of integrating or packaging the circuit, or implemented in any one of the three implementation methods of software, hardware, and firmware, or in a suitable combination of any of them. Alternatively, at least one of the first feature combination module 1110, the first correlation processing module 1120 and the first depth estimation module 1130 may be at least partially implemented as a computer program module, and when the computer program module is executed, the corresponding function may be performed.

Based on the above-mentioned training method of the depth estimation model, one embodiment of the present disclosure also provides a training device for the depth estimation model. The device will be described in detail below in conjunction with FIG. 12.

FIG. 12 schematically shows a structural block diagram of a training device for a depth estimation model according to an embodiment of the present disclosure.

As shown in FIG. 12, the training device 1200 for the depth estimation model of this embodiment includes a second feature combining module 1210, a second correlation processing module 1220, a second depth estimating module 1230 and an iterative adjusting module 1240.

The second feature combination module 1210 is configured to perform feature combination on the sample image feature volumes of each sample image group for at least two sample image groups obtained by grouping sample images involving different orientations in a sample scene based on the training samples, so as to obtain at least two sample panoramic feature volumes, wherein the sample images contained in each sample image group cover a panoramic field of view of the sample scene, and the sample image feature volume represents three-dimensional stereoscopic features of the sample image.

The second correlation processing module 1220 is configured to perform correlation processing on every two sample panoramic features in the at least two sample panoramic feature volumes to obtain at least one sample correlation volume.

The second depth estimation module 1230 is configured to perform panoramic depth estimation based on the initial depth map and the at least one sample correlation volume to obtain a predicted panoramic depth map for the sample scene.

The iterative adjustment module 1240 is configured to determine loss information of the depth estimation model according to the predicted panoramic depth map, and iteratively adjust network parameters of the depth estimation model according to the loss information until the loss information meets an iteration stop condition, and the network parameters obtained when the iteration stop condition is met are used as the trained depth estimation model.

According to an embodiment of the present disclosure, each sample image feature volume has its own sample weight.

According to an embodiment of the present disclosure, the second feature combination module includes: a second weighted sum processing submodule.

The second weighted sum processing submodule is configured to perform weighted sum processing on the sample image feature volumes of each sample image group using the sample weights of each sample image feature volume to obtain at least two sample panoramic feature volumes.

According to an embodiment of the present disclosure, the above-mentioned training device also includes: a third cascade module and a third multilayer perception module.

The third cascade module is configured to perform cascade processing on the sample image feature volumes in the sample image group for each sample image group to obtain the sample image feature volumes after the first cascade.

The third multilayer perception module is configured to perform multilayer perception processing on the sample image feature volumes after the first cascade to obtain the sample weights of the sample image feature volumes in the sample image group.

According to an embodiment of the present disclosure, the above-mentioned training device further includes: a fourth determination module, a fifth determination module and a sixth determination module.

The fourth determination module is configured to determine, for each sample pixel in the sample image feature volume, a distance between a sample pixel and a target sample pixel.

The fifth determination module is configured to determine a position weight for the sample pixel according to the distance.

The sixth determination module is configured to determine the sample weight of the sample image feature volume according to the position weight of each sample pixel point.

According to an embodiment of the present disclosure, the fifth determination module includes: a third determination submodule and a fourth determination submodule.

The third determining submodule is configured to determine that the position weight of the sample pixel point is a first value when the determined distance is less than a preset distance threshold.

The fourth determination submodule is configured to determine that the position weight of the sample pixel point is a second value when the distance is determined to be greater than or equal to a preset distance threshold, wherein the first value is different from the second value.

According to an embodiment of the present disclosure, the above-mentioned training device also includes: a fourth cascade module and a fourth multilayer perception module.

The fourth cascade module is configured to perform cascade processing on the sample image feature volumes of the sample images at different orientations in the sample scene to obtain the sample image feature volumes after the second cascade.

The fourth multilayer perception module is configured to perform multilayer perception processing on the sample image feature volume after the second cascade to obtain the sample weight of each sample image feature volume.

According to an embodiment of the present disclosure, the above-mentioned training device also includes: a second division module.

The second division module is used to arrange two sample images facing back to back into a sample image group for sample images involving different orientations in the sample scene, thereby obtaining at least two sample image groups, wherein the two sample images facing back to back represent that the orientations of the two sample images are opposite.

According to an embodiment of the present disclosure, the second correlation processing module includes: a second inner product calculation submodule.

The second inner product calculation submodule is configured to perform inner product calculation on every two sample panoramic feature volumes of the at least two sample panoramic feature volumes to obtain at least one sample correlation volume.

According to an embodiment of the present disclosure, the second depth estimation module includes: a second depth estimation submodule.

The second depth estimation submodule is configured to perform panoramic depth estimation based on the initial depth map, a preset sample context feature volume and at least one sample correlation volume to obtain a sample panoramic depth map for the sample scene, wherein the sample context feature volume is determined based on at least one sample panoramic feature volume.

According to an embodiment of the present disclosure, the second depth estimation submodule includes: a second depth estimation unit, a second updating unit and a second circulation unit.

The second depth estimation unit is configured to use the initial depth map as the current sample depth estimation map, perform panoramic depth estimation based on the current sample depth estimation map, the sample context feature volume and at least one sample correlation volume to obtain a sample depth estimation increment.

The second updating unit is configured to update the current sample depth estimation map according to the sample depth estimation increment to obtain an updated sample estimation depth map.

The second loop unit is configured to use the updated sample depth estimation as the current sample depth estimation map, and cyclically execute the above operation until the number of loops reaches a second preset loop threshold, thereby obtaining a sample panoramic depth map for the sample scene.

According to an embodiment of the present disclosure, the second depth estimation unit includes: a second depth subunit and a sampling subunit.

The second depth estimation subunit is configured to sample a sample context feature volume and at least one sample correlation volume respectively by using the current sample depth estimation map and the preset sampling neighborhood value to obtain a current sample context feature map and a current sample correlation feature map.

The second sampling subunit is configured to perform panoramic depth estimation by using the current sample context feature map and the current sample correlation feature map to obtain a sample depth estimation increment.

According to an embodiment of the present disclosure, the training device further includes: a second feature extraction module and a second spherical scanning module.

The second feature extraction module is configured to extract features from each sample image in the sample images of different orientations in the sample scene to obtain a sample feature map.

The second spherical scanning module is configured to perform spherical scanning processing on the sample feature map to obtain a sample image feature volume.

According to an embodiment of the present disclosure, the sample images involving different orientations in the sample scene include sample images in at least four orientations.

According to an embodiment of the present disclosure, sample images involving different orientations in a sample scene are acquired by using fisheye lenses involving different orientations in the sample scene.

According to an embodiment of the present disclosure, any multiple modules of the second feature combination module 1210, the second correlation processing module 1220, the second depth estimation module 1230 and the iterative adjustment module 1240 can be combined into one module for implementation, or any one of the modules can be split into multiple modules. Alternatively, at least part of the functions of one or more of these modules can be combined with at least part of the functions of other modules and implemented in one module. According to an embodiment of the present disclosure, at least one of the second feature combination module 1210, the second correlation processing module 1220, the second depth estimation module 1230 and the iterative adjustment module 1240 can be at least partially implemented as a hardware circuitry, such as a field programmable gate array (FPGA), a programmable logic array (PLA), a system on a chip, a system on a substrate, a system on a package, an application specific integrated circuit (ASIC), or can be implemented by hardware or firmware such as any other reasonable way of integrating or packaging the circuit, or implemented in any one of the three implementation modes of software, hardware and firmware or in a suitable combination of any of them. Alternatively, at least one of the second feature combination module 1210, the second correlation processing module 1220, the second depth estimation module 1230 and the iterative adjustment module 1240 may be at least partially implemented as a computer program module, which may perform corresponding functions when executed.

An embodiment of the present disclosure further provides an electronic device, comprising: one or more processors; and a memory for storing one or more computer programs, wherein the one or more processors execute the one or more computer programs to implement the steps of the method.

An embodiment of the present disclosure further provides an unmanned vehicle, comprising the above-mentioned electronic device.

An embodiment of the present disclosure further provides a non-transitory computer-readable storage medium on which a computer program or instruction is stored. When the computer program or instruction is executed by a processor, the steps of the above method are implemented.

An embodiment of the present disclosure further provides a computer program product, including a computer program or instructions, which implement the steps of the above method when executed by a processor.

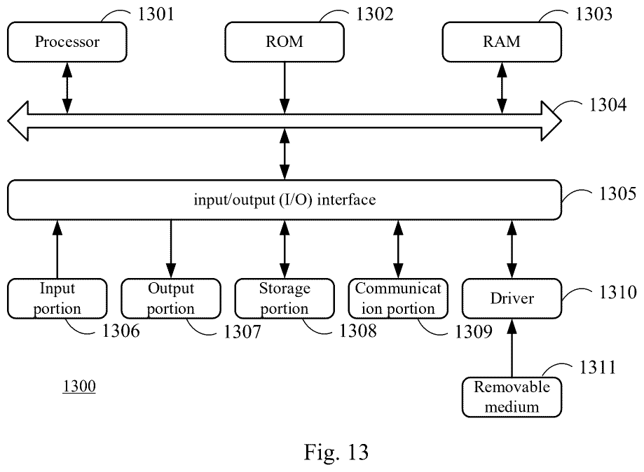

FIG. 13 schematically shows a block diagram of an electronic device suitable for implementing the above method according to an embodiment of the present disclosure.

As shown in FIG. 13, the electronic device 1300 according to an embodiment of the present disclosure includes a processor 1301, which can perform various appropriate actions and processes according to a program stored in a read-only memory (ROM) 1302 or a program loaded from a storage 1308 to a random access memory (RAM) 1303. The processor 1301 may include, for example, a general-purpose microprocessor (e.g., a CPU), an instruction set processor and/or a related chipset and/or a dedicated microprocessor (e.g., an application-specific integrated circuit (ASIC), etc. The processor 1301 may also include an onboard memory for caching purposes. The processor 1301 may include a single processing unit or multiple processing units for performing different actions of the method flow according to an embodiment of the present disclosure.

In RAM 1303, various programs and data required for the operation of electronic device 1300 are stored. Processor 1301, ROM 1302 and RAM 1303 are connected to each other through bus 1304. Processor 1301 performs various operations of the method flow according to the embodiment of the present disclosure by executing the program in ROM 1302 and/or RAM 1303. It should be noted that the program can also be stored in one or more memories other than ROM 1302 and RAM 1303. Processor 1301 can also perform various operations of the method flow according to the embodiment of the present disclosure by executing the programs stored in the one or more memories.

According to an embodiment of the present disclosure, the electronic device 1300 may further include an input/output (I/O) interface 1305, which is also connected to the bus 1304. The electronic device 1300 may further include one or more of the following components connected to the input/output (I/O) interface 1305: an input portion 1306 including a keyboard, a mouse, etc.; an output portion 1307 including a cathode ray tube (CRT), a liquid crystal display (LCD), etc., and a speaker, etc.; a storage portion 1308 including a hard disk, etc.; and a communication portion 1309 including a network interface card such as a LAN card, a modem, etc. The communication portion 1309 performs communication processing via a network such as the Internet. A driver 1310 is also connected to the input/output (I/O) interface 1305 as needed. A removable medium 1311, such as a magnetic disk, an optical disk, a magneto-optical disk, a semiconductor memory, etc., is installed on the driver 1310 as needed, so that a computer program read therefrom is installed into the storage portion 1308 as needed.

The present disclosure also provides a computer-readable storage medium, which may be included in the device/apparatus/system described in the above embodiments; or may exist independently without being assembled into the device/apparatus/system. The above computer-readable storage medium carries one or more programs, and when the above one or more programs are executed, the method according to the embodiment of the present disclosure is implemented.

According to an embodiment of the present disclosure, a computer-readable storage medium may be a non-volatile computer-readable storage medium, for example, may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination thereof. In the present disclosure, a computer-readable storage medium may be any tangible medium containing or storing a program, which may be used by or in combination with an instruction execution system, an apparatus, or a device. For example, according to an embodiment of the present disclosure, a computer-readable storage medium may include the ROM 1302 and/or RAM 1303 described above and/or one or more memories other than ROM 1302 and RAM 1303.

One embodiment of the present disclosure also includes a computer program product, which includes a computer program, and the computer program contains program code for executing the method shown in the flowchart. When the computer program product is run in a computer system, the program code is configured to enable the computer system to implement the method provided by the embodiment of the present disclosure.

The above functions defined in the system/device of the embodiment of the present disclosure are performed when the computer program is executed by the processor 1301. According to the embodiment of the present disclosure, the system, device, module, unit, etc. described above can be implemented by a computer program module.

In one embodiment, the computer program may rely on tangible storage media such as optical storage devices, magnetic storage devices, etc. In another embodiment, the computer program may also be transmitted and distributed in the form of signals on a network medium, and downloaded and installed through the communication portion 1309, and/or installed from the removable medium 1311. The program code contained in the computer program may be transmitted using any appropriate network medium, including but not limited to: wireless, wired, etc., or any suitable combination of the above.

In such an embodiment, the computer program can be downloaded and installed from the network through the communication portion 1309, and/or installed from the removable medium 1311. When the computer program is executed by the processor 1301, the above functions defined in the system of the embodiment of the present disclosure are performed. According to the embodiment of the present disclosure, the system, device, apparatus, module, unit, etc. described above can be implemented by a computer program module.

According to an embodiment of the present disclosure, the program code for executing the computer program provided by the embodiment of the present disclosure can be written in any combination of one or more programming languages. Specifically, these computing programs can be implemented using high-level process and/or object-oriented programming languages, and/or assembly/machine languages. Programming languages include, but are not limited to, Java, C++, python, “C” language or similar programming languages. The program code can be executed entirely on the user computing device, partially on the user device, partially on the remote computing device, or entirely on the remote computing device or server. In the case of a remote computing device, the remote computing device can be connected to the user computing device through any type of network, including a local area network (LAN) or a wide area network (WAN), or can be connected to an external computing device (for example, using an Internet service provider to connect through the Internet).

The flow chart and block diagram in the accompanying drawings illustrate the possible architecture, functions and operations of the system, method and computer program product according to various embodiments of the present disclosure. In this regard, each box in the flow chart or block diagram can represent a module, a program segment, or a part of a code, and the above-mentioned module, program segment, or a part of the code contains one or more executable instructions for realizing the specified logical function. It should also be noted that in some alternative implementations, the functions marked in the box can also occur in a different order from the order marked in the accompanying drawings. For example, two boxes represented in succession can actually be executed substantially in parallel, and they can sometimes be executed in the opposite order, depending on the functions involved. It should also be noted that each box in the block diagram or flow chart, and the combination of the boxes in the block diagram or flow chart can be implemented with a dedicated hardware-based system that performs a specified function or operation, or can be implemented with a combination of dedicated hardware and computer instructions.

It will be appreciated by those skilled in the art that the features described in the various embodiments of the present disclosure may be combined and/or recombined in a variety of ways, even if such combinations or combinations are not explicitly described in the present disclosure. In particular, without departing from the spirit and teachings of the present disclosure, the features described in the various embodiments of the present disclosure may be combined and/or recombined in a variety of ways. All of these combinations and/or re-combinations fall within the scope of the present disclosure.

Some embodiments of the present disclosure are described above. However, these embodiments are only for illustrative purposes and are not intended to limit the scope of the present disclosure. Although the embodiments are described above, this does not mean that the measures in the various embodiments cannot be used in combination to advantage. Without departing from the scope of the present disclosure, those skilled in the art may make a variety of substitutions and modifications, which should all fall within the scope of the present disclosure.

What is claimed is:

1. A method for generating a target panoramic depth map, comprising:
grouping target images involving different orientations in a target scene to form at least two image groups, the target images in each of the at least two image groups covering a panoramic field of view of the target scene;
performing feature combination on target image feature volumes of each of the image groups to obtain at least two target panoramic feature volumes, each of the target image feature volumes representing three-dimensional stereoscopic features of one of the target images;
performing correlation processing on every two of the at least two target panoramic feature volumes to obtain at least one target correlation volume; and
performing panoramic depth estimation based on an initial depth map and the at least one target correlation volume to obtain the target panoramic depth map for the target scene.

2. The method according to claim 1, wherein each of the target image feature volumes has a corresponding target weight, and the performing feature combination on target image feature volumes of each of the image groups to obtain at least two target panoramic feature volumes comprises:
performing weighted summation of target weight of each of the target image feature volumes in each of the image groups to obtain the at least two target panoramic feature volumes.

3. The method according to claim 2, wherein the target weight of each of the target image feature volumes is determined by following operations:
performing cascade processing on the target image feature volumes in each of the image groups to obtain a target image feature volume after first cascade respectively; and
performing multilayer perception processing on the target image feature volume after the first cascade to obtain the target weight of each of the target image feature volumes in each of the image groups.

4. The method according to claim 2, wherein the target weight of each of the target image feature volume is determined by following operations:
for each pixel point in each of the target image feature volumes, determining a distance between a pixel point and a target pixel point, wherein the target pixel point corresponds to a center of a camera;
determining a position weight of the pixel point according to the distance; and
determining the target weight of each of the target image feature volume according to the position weight of each pixel point.

5. The method according to claim 4, wherein the determining the position weight of the pixel point according to the distance comprises:
in a case that that the distance is less than a preset distance threshold, determining the position weight of the pixel point to be a first value; and
in a case that the distance is greater than or equal to the preset distance threshold, determining the position weight of the pixel point to be a second value,
wherein the first value is different from the second value.

6. The method according to claim 2, wherein the target weight of each of target image feature volumes is determined by following operations:
Performing cascade processing on the target image feature volumes of the target images involving different orientations in the target scene to obtain a target image feature volume after second cascade; and
performing multilayer perception processing on the target image feature volume after the second cascade to obtain the target weight of each of target image feature volumes.

7. The method according to claim 1, wherein the grouping target images involving different orientations in the target scene to form the at least two image groups comprises:
grouping every two target images facing back to back among the target images involving different orientations in a target scene into one image group to obtain the at least two image groups,
wherein the two target images facing back to back represent that the orientations of the two target images are opposite.

8. The method according to claim 1, wherein the performing correlation processing on every two of the at least two target panoramic feature volumes to obtain at least one target correlation volume comprises:
performing an inner product calculation on the every two of the at least two target panoramic feature volumes to obtain the at least one target correlation volume.

9. The method according to claim 1, wherein the performing panoramic depth estimation based on the initial depth map and the at least one target correlation volume to obtain the target panoramic depth map for the target scene comprises:
performing the panoramic depth estimation based on the initial depth map, a preset target context feature volume and the at least one target correlation volume to obtain the target panoramic depth map for the target scene,
wherein the target context feature volume is determined based on at least one of the target panoramic feature volumes.

10. The method according to claim 9, wherein the performing panoramic depth estimation based on the initial depth map, the preset target context feature volume and the at least one target correlation volume to obtain the target panoramic depth map for the target scene comprises:
using the initial depth map as a current depth estimation map, performing the panoramic depth estimation based on the current depth estimation map, the target context feature volume and the at least one target correlation volume to obtain a depth estimation increment;
updating the current depth estimation map according to the depth estimation increment to obtain an updated depth estimation map; and
using the updated depth estimation as the current depth estimation map, performing above operations of performing the panoramic depth estimation and updating the current depth estimation map in a loop until a number of loops reaches a first preset loop threshold, thereby obtaining the target panoramic depth map for the target scene.

11. The method according to claim 10, wherein the performing panoramic depth estimation based on the current depth estimation map, the target context feature volume and the at least one target correlation volume to obtain the depth estimation increment comprises:
using the current depth estimation map and a preset sampling neighborhood value, sampling the target context feature volume and the at least one target correlation volume respectively to obtain a current context feature map and a current correlation feature map; and
performing the panoramic depth estimation based on the current context feature map and the current correlation feature map to obtain the depth estimation increment.

12. The method according to claim 1, further comprising:
performing feature extraction on each of the target images to obtain a target feature map respectively; and
performing spherical scanning processing on the target feature map to obtain a target image feature volume for each of the target images.

13. The method according to claim 1, wherein the target images involving different orientations in the target scene include target images in at least four orientations.

14. The method according to claim 1, wherein target images involving different orientations in the target scene are acquired by fisheye lenses at different orientations in the target scene.

15. The method according to claim 1, further comprising:
determining obstacles according to the panoramic depth map; and
controlling an unmanned vehicle to perform obstacle avoidance processing according to the obstacles.

16. A method for training a depth estimation model, comprising:
grouping sample images involving different orientations in a sample scene based on training samples to form at least two sample image groups, the sample images in each of the at least two sample image groups covering a panoramic field of view of the sample scene;
performing feature combination on sample image feature volumes of each of the sample image groups to obtain at least two sample panoramic feature volumes, each of the sample image feature volumes representing three-dimensional features of one of the sample images;
performing correlation processing on every two of the at least two sample panoramic feature volumes to obtain at least one sample correlation volume;
performing panoramic depth estimation based on an initial depth map and the at least one sample correlation volume to obtain a predicted panoramic depth map for the sample scene;
determining loss information of the depth estimation model according to the predicted panoramic depth map;
adjusting network parameters of the depth estimation model iteratively according to the loss information until the loss information satisfies an iteration stop condition, and
determining the network parameters obtained when the loss information satisfies the iteration stop condition as the trained depth estimation model.

17. An electronic device, comprising:
at least one processor; and
at least one memory for storing at least one program,
wherein, the at least one processor, when executing the at least one program, is configured to:
group target images involving different orientations in a target scene to form at least two image groups, the target images in each of the at least two image groups covering a panoramic field of view of the target scene;
perform feature combination on target image feature volumes of each of the image groups to obtain at least two target panoramic feature volumes, each of the target image feature volumes representing three-dimensional stereoscopic features of one of the target images;
perform correlation processing on every two of the at least two target panoramic feature volumes to obtain at least one target correlation volume; and
perform panoramic depth estimation based on an initial depth map and the at least one target correlation volume to obtain the target panoramic depth map for the target scene.

18. The electronic device according to claim 17, wherein the at least one processor is further configured to:
determine obstacles according to the target panoramic depth map; and
control an unmanned vehicle to perform obstacle avoidance processing according to the obstacles.

19. An unmanned vehicle comprising the electronic device according to claim 17.

20. The unmanned vehicle of claim 18, wherein the unmanned vehicle comprises an unmanned aerial vehicle or an unmanned robot.
